(19) United States
(12) Patent Application Publication
(10) Pub. No.: US 2011/0179375 A1
(43) Pub. Date: Jul. 21, 2011

(54) Popping and Ghosting Tabs from Tabbed Groups in Graphical User Interfaces

(75) Inventors: Lauren M. Shupp, Durham, NC (US); Theresa D. Ramsey, Durham, NC (US)

(73) Assignee: INTERNATIONAL BUSINESS MACHINES CORPORATION, Armonk, NY (US)

(21) Appl. No.: 12/690,462

(22) Filed: Jan. 20, 2010

(51) Int. Cl. G06F 3/048

(52) U.S. Cl. 715/777; 715/788

(57) ABSTRACT

A method, system, and computer-usable medium are disclosed for the management of tabbed panels within a graphical user interface (GUI). A tabbed pane, comprising a plurality of overlying panels, each with a viewable tab, is displayed within the GUI. A tab is selected and its corresponding panel and associated elements is replicated for display in a pop-out window. Visual attributes are then applied to the tab of the selected panel wherever the tab is shown to signify the association of the selected tab with the pop-out window.

### BACKGROUND OF THE INVENTION

1. Field of the Invention

Embodiments of the disclosure relate in general to the field of computers and similar technologies, and in particular to software utilized in this field. Still more particularly, it relates to the management of tabbed panels within a graphical user interface (GUI).

2. Description of the Related Art

Current information processing systems are typically provided with a Graphical User Interface (GUI), which allows a user to interact with programs running on a computer using graphical elements such as windows, dialog boxes, and pop-up or pull-down menus. One such element is a tabbed pane consisting of overlying components, generally panels, which share a common space within the GUI. These panels resemble a stack of paper sheets lying one on top of another, each with a viewable tab, with only the topmost panel visible to the user.

To view a panel, a user selects a tab, its corresponding panel is then popped up and moved to the top of the stack, and the other panels are hidden from view. While convenient, current tab-based interfaces pose certain limitations and in some usage scenarios can prove to be unwieldy and inflexible. For example, a user is forced to continually switch between tabs to compare content between two, or more, tabbed panes or views. This is both time consuming and confusing.

### BRIEF SUMMARY OF THE INVENTION

The present invention includes, but is not limited to, a method, system, and computer-usable medium for the management of tabbed panels within a graphical user interface (GUI). In various embodiments, a tab management module is implemented with a GUI. A tabbed pane, comprising a plurality of overlying panels is displayed within the GUI. Each panel has a viewable tab, with only the topmost panel visible to the user. To view a panel, and the elements it contains, a user selects a tab, its corresponding panel is then moved to the top of the stack, and the other panels are hidden from view. The selected panel and its associated elements are then replicated in a pop-out window. Visual attributes are then applied to the tab of the selected panel. In one embodiment, a translucent attribute is applied to the tab and its text to render a ghosted appearance.

The elements associated with the selected panel are then displayed within the pop-out window. In one embodiment, the user is prevented from manipulating or modifying the elements either in the selected panel or in the pop-out window. In another embodiment, the elements are displayed in the pop-out window, but can only be manipulated or modified within the selected panel. In yet another embodiment, the elements may be displayed, manipulated, and modified within the pop-out window. In these embodiments, any manipulation or modification of elements is synchronized with the elements contained in the selected panel and pop-out window.

In one embodiment, first and second tabs are selected by a user and their panels and associated elements are respectively replicated in a first and second pop-out window. A first visual attribute is applied to the first tab and a second visual attribute is applied to the second tab to signify the respective association of the first and second tabs with their corresponding pop-out windows. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 is a flowchart of an implementation of a tab management module; and

FIGS. 3a-d show the implementation of a tab management module within a graphical user interface.

### DETAILED DESCRIPTION

A method, system, and computer-usable medium are disclosed for the management of tabbed panels within a graphical user interface (GUI). As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate the program for use by or in connection with the instruction execution system, apparatus, or device. The computer-usable medium may include a data signal with the computer-usable program code embodied therein, either in baseband or as part of a carrier wave. The computer usable program code may be transmitted using any appropriate medium, including but not limited to the Internet, wire line, optical fiber cable, and radio frequency (RF), etc.

Computer program code for carrying out operations of the present invention may be written in an object oriented programming language such as Java, Smalltalk, C++, or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

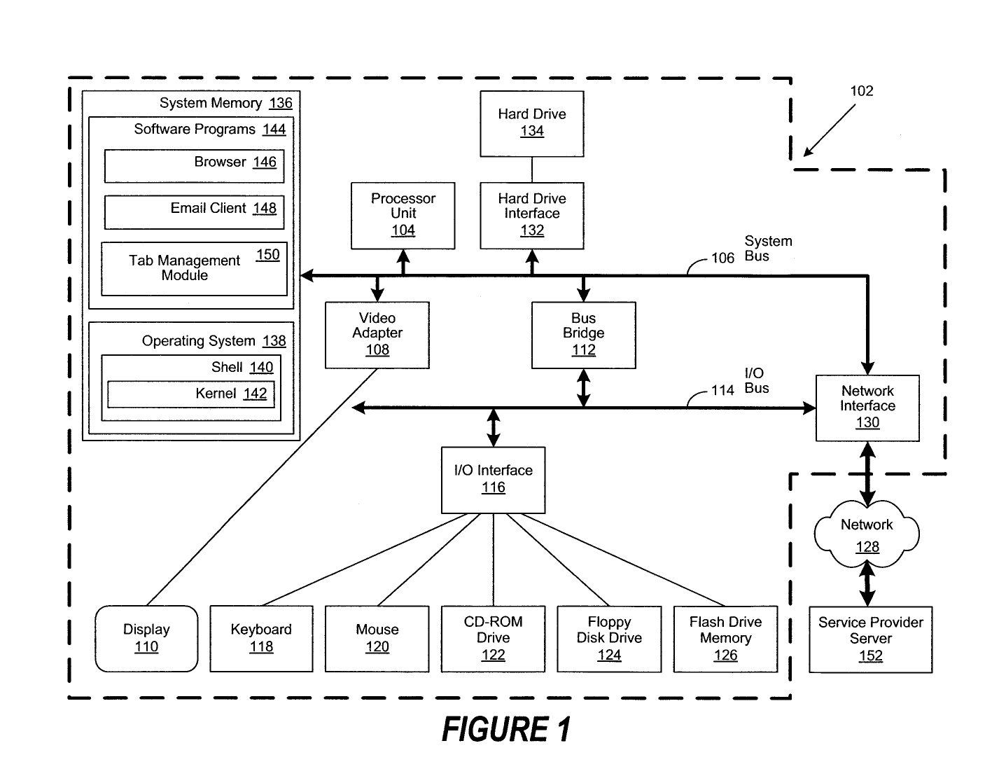

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy, and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management.

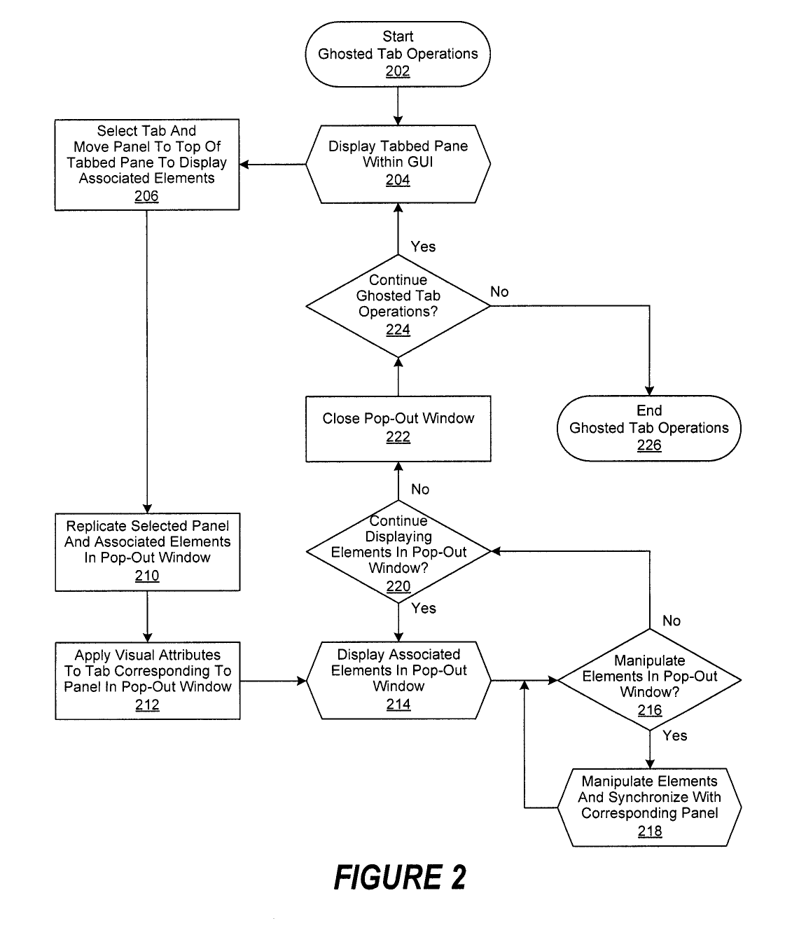

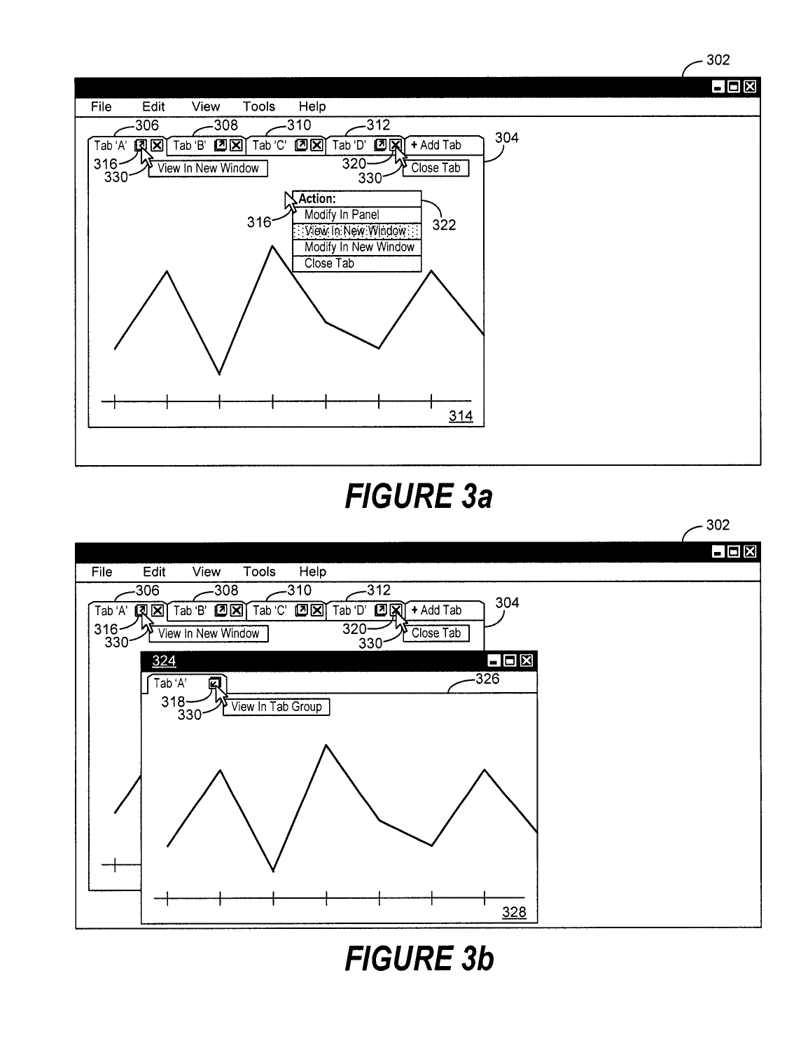

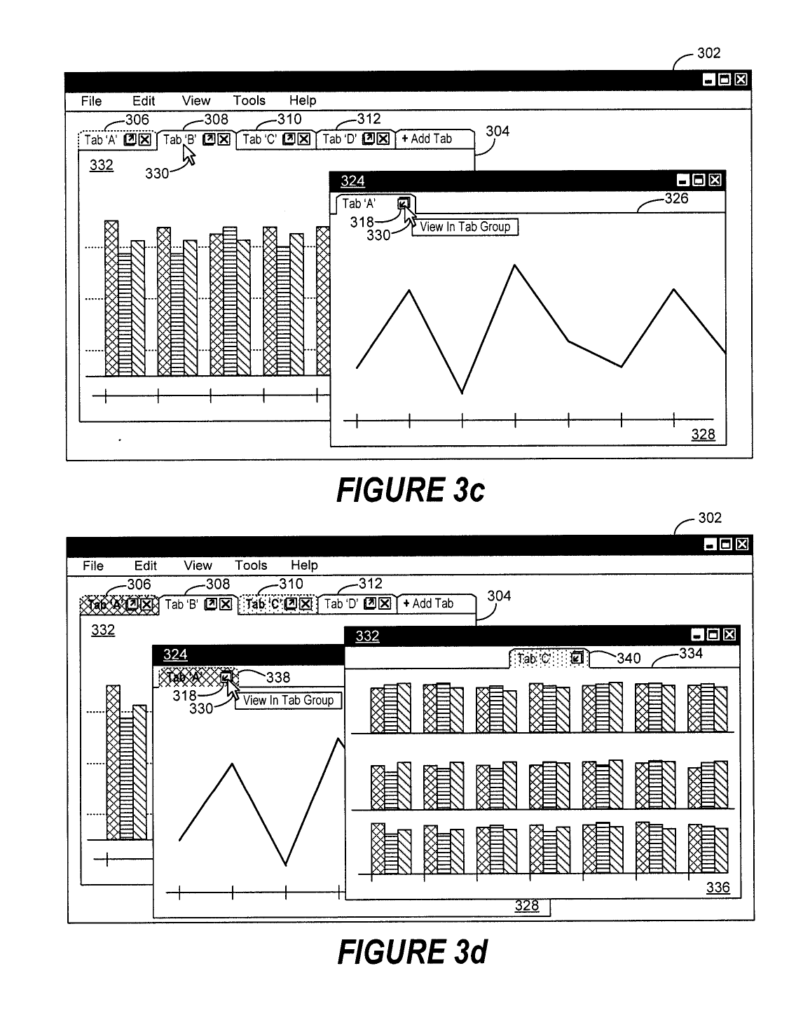

Software programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. Software programs 144 also include a tab management module 150. The tab management module 150 includes code for implementing the processes described in FIGS. 2 through 3 described herein. In one embodiment, client computer 102 is able to download the tab management module 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 is a flowchart of an implementation of a tab management module in accordance with an embodiment of the invention. In this embodiment, ghosted tab operations are started in step 202 with the implementation of a tab management module with a graphical user interface (GUI). In step 204, a tabbed pane is displayed within the GUI. As used herein, a tabbed pane is defined as a plurality of overlying components, generally panels, which share a common space within the GUI. Each panel has a viewable tab, with only the topmost panel visible to the user. To view a panel, and the elements it contains, a user selects a tab in step 206, its corresponding panel is then popped up and moved to the top of the stack, and the other panels are hidden from view. The selected panel, and its associated elements, is then replicated in a pop-out window in step 210. As used herein, a pop-out window is a separate window in the GUI that comprises a selected panel and its associated elements. In various embodiments, the pop-out window is associated with a graphical element within a GUI. In these and other embodiments, elements may or may not be visible within the GUI until the graphical element is manipulated, such as with a user gesture. Once manipulated, the elements associated with the graphical elements are displayed within the pop-out window. It will be apparent to skilled practitioners of the art that many such embodiments are possible and that the pop-out window is not limited solely to tabbed panels.

Visual attributes are then applied to the tab of the selected panel in step 212. In one embodiment, a translucent attribute is applied to the tab and its text to render a ghosted appearance. In another embodiment, a color attribute (e.g., blue) is applied to the background of the tab. In yet another embodiment, a color attribute is applied to the text of the tab. In still another embodiment, an audio attribute, such as an associated sound effect, is applied to the tab, the text of the tab, or an icon associated with the tab. It will be apparent to those of skill in the art that many such visual and audio attributes may be applied to the tab, its associated text, or an associated icon. Furthermore, animation effects may likewise be applied to the aforementioned elements in various other embodiments. It will be apparent to those of skill in the art that many such embodiments are possible and the foregoing are provided as examples and are not intended to limit the intent, spirit or scope of the invention.

The elements associated with the selected panel are then displayed within the pop-out window in step 214. Once displayed, a decision is made in step 216 whether the elements displayed within the pop-out window will be manipulated by the user. If so, then the displayed elements are manipulated by the user in step 218. In one embodiment, the user is prevented from manipulating or modifying the elements either in the selected panel or in the pop-out window. In another embodiment, the elements are displayed in the pop-out window, but can only be manipulated or modified within the selected panel. In yet another embodiment, the elements may be displayed, manipulated, and modified within the pop-out window. In these embodiments, any manipulation or modification of elements is synchronized with the elements contained in the selected panel and pop-out window.

If it is decided in step 216 to not manipulate the elements displayed within the pop-out window, then a decision is made in step 220 whether to continue displaying the elements in the pop-out window. If so, then the process continues, proceeding with step 214. Otherwise, the pop-out window is closed in step 222. Once the pop-out window is closed, then a decision is made in step 224 whether or not to continue ghosted tab operation. If so, the process in continued, proceeding with step 204. Otherwise, ghosted tab operations are ended in step 226.

FIGS. 3a-d show the implementation of a tab management module within a graphical user interface (GUI) in accordance with an embodiment of the invention. Referring now to FIG. 3a, GUI 302 comprises tabbed pane 304, further comprising tabbed panel ‘A’ 306, ‘B’ 308, ‘C’ 310, and ‘D’ 312. Tabbed panel ‘A’ 306 further comprises associated elements 314 and Pop-Out Window icon 316. In one embodiment, the replication of tabbed panel ‘A’ 306 and it associated elements 314 into a pop-out window is initiated with a user gesture, such as a mouse click with cursor 330 on Pop-Out Window icon 316. In another embodiment, the replication is initiated with a user gesture, such as a mouse right-click with cursor 330 on a menu selection within tab management menu 322. As an example, the user may choose to replicate tabbed panel ‘A’ 306 and it associated elements 314 into a pop-out window for viewing only. As another example, the user may choose to replicate tabbed panel ‘A’ 306 and it associated elements 314 into a pop-out window for manipulation or modification. In one embodiment, as shown with tab ‘D’ 312, the tabbed panel is closed through a user gesture, such as a mouse click with cursor 330 on the Close Tab icon 320.

As shown in FIG. 3b, tabbed panel ‘A’ 306 and its associated elements 314 have been replicated into pop-out window 324. Accordingly, pop-out window comprises replicated tabbed panel ‘A’ 326, further comprising replicated, associated elements 328. In one embodiment, a translucent visual attribute is applied to the tab of tabbed panel ‘A’ 306 to create a ghosted tab and to signify that tabbed panel ‘A’ 306 and its associated elements 314 are replicated in pop-out window 324.

In one embodiment, the user is prevented from manipulating or modifying the associated elements 314 or associated, replicated elements 328, respectively, either in the tabbed panel ‘A’ 306 or the pop-out window 324. In another embodiment, the replicated, associated elements 328 are displayed in the replicated panel ‘A’ 326 of the pop-out window 324, but only the associated elements 314 contained within the tabbed panel ‘A’ 306 can be manipulated or modified. In yet another embodiment, the associated elements 314 or associated, replicated elements 328, respectively, may be displayed, manipulated and modified within the tabbed panel ‘A’ 306 or pop-out window 324. In these embodiments, any manipulation or modification of the associated elements 314 or associated, replicated elements 328, is respectively synchronized with their corresponding elements contained in the tabbed panel ‘A’ 306 and the replicated panel ‘A’ 326 of pop-out window 324. In one embodiment, pop-out window 324 is closed with a user gesture, such as a mouse click with cursor 330 on View In Tab Group icon 318. In another embodiment, the ability for the user to manipulate and modify the associated elements 314 of tabbed window ‘A’ 306 is restored upon the closing of pop-out window 324.

Referring now to FIG. 3c, tabbed panel ‘A’ 306 and its associated elements 314 have been replicated into pop-out window 324 and tabbed panel ‘B’ 308 has been selected through a user gesture, such as a mouse click with cursor 330. Accordingly, the associated elements 332 of tabbed window ‘B’ are now displayed as the top panel in tabbed pane 304. Likewise, a translucent visual attribute has been applied to tab of tabbed panel ‘A’ 306 to create a ghosted tab and to signify that tabbed panel ‘A’ 306 and its associated elements 314 are replicated in pop-out window 324.

Referring now to FIG. 3d, the associated elements 332 of tabbed window ‘B’ are now displayed as the top panel in tabbed pane 304. A first translucent visual attribute has been applied to the tab of tabbed panel ‘A’ 306 and to the tab 338 of replicated tabbed panel ‘A’ 326 to signify their association. Likewise, tabbed panel ‘C’ 310 and its associated elements 336 have been replicated into pop-out window 332. A second translucent visual attribute has been applied to the tab of tabbed panel ‘C’ 310 and to the tab 340 of replicated tabbed panel ‘C’ 334 to signify their association. It will be apparent to those of skill in the art that many such embodiments are possible and the foregoing embodiments are not intended to limit the spirit or scope of the invention.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of skill in the art without departing from the scope and spirit of the invention. The embodiment was chosen and described to best explain the principles of the invention and the practical application, and to enable others of skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for managing tabbed panels within a graphical user interface (GUI), comprising:
providing a plurality of tabs within a tabbed pane of a GUI, wherein each tab has associated elements;
receiving user input to select a tab;
displaying the associated elements of the selected tab within a panel of the tabbed pane;
receiving user input to replicate the associated elements of the selected tab for display within a window of the GUI;
replicating the associated elements for display within the window; and
associating the selected tab with the window, wherein the association is signified by changing a visual attribute of the selected tab.

2. The method of claim 1, wherein receiving user input to select a tab comprises:
receiving user input to select a first tab and a second tab;
displaying the associated elements of the first and second selected tab respectively within a first and second panel of the tabbed pane;
receiving user input to replicate the associated elements of the first and second selected tab respectively for display within a first and second window of the GUI;
replicating the associated elements for display within the first and second window; and
associating the first and second selected tab respectively with the first and second window, wherein the association is signified by respectively changing a visual attribute of the first and second selected tab.

3. The method of claim 1, wherein the replication prevents user manipulation of the elements within at least one of:
the panel;
the window; and
the panel and the window.

4. The method of claim 1, wherein user manipulation of the elements in the window is replicated within the panel.

5. The method of claim 1, wherein user manipulation of the elements in the panel is replicated within the window.

6. The method of claim 1, wherein discontinuing the display of the associated elements in the window removes the visual attribute applied to the selected tab.

7. A system comprising:
a processor;
a data bus coupled to the processor; and
a computer-readable medium embodying computer program code, the computer-usable medium being coupled to the data bus, the computer program code managing tabbed panels within a graphical user interface (GUI) and comprising instructions executable by the processor and configured for:
providing a plurality of tabs within a tabbed pane of a GUI, wherein each tab has associated elements;
receiving user input to select a tab;
displaying the associated elements of the selected tab within a panel of the tabbed pane;
receiving user input to replicate the associated elements of the selected tab for display within a window of the GUI;
replicating the associated elements for display within the window; and
associating the selected tab with the window, wherein the association is signified by changing a visual attribute of the selected tab.

8. The system of claim 7, wherein receiving user input to select a tab comprises:
receiving user input to select a first tab and a second tab;
displaying the associated elements of the first and second selected tab respectively within a first and second panel of the tabbed pane;
receiving user input to replicate the associated elements of the first and second selected tab respectively for display within a first and second window of the GUI;
replicating the associated elements for display within the first and second window; and
associating the first and second selected tab respectively with the first and second window, wherein the association is signified by respectively changing a visual attribute of the first and second selected tab.

9. The system of claim 7, wherein the replication prevents user manipulation of the elements within at least one of:
the panel;
the window; and
the panel and the window.

10. The system of claim 7, wherein user manipulation of the elements in the window is replicated within the panel.

11. The system of claim 7, wherein user manipulation of the elements in the panel is replicated within the window.

12. The system of claim 7, wherein discontinuing the display of the associated elements in the window removes the visual attribute applied to the selected tab.

13. A computer-readable medium embodying computer program code, the computer program code comprising computer executable instructions configured for:
providing a plurality of tabs within a tabbed pane of a GUI, wherein each tab has associated elements;
receiving user input to select a tab;
displaying the associated elements of the selected tab within a panel of the tabbed pane;
receiving user input to replicate the associated elements of the selected tab for display within a window of the GUI;
replicating the associated elements for display within the window; and
associating the selected tab with the window, wherein the association is signified by changing a visual attribute of the selected tab.

14. The computer usable medium of claim 13, wherein receiving user input to select a tab comprises:
receiving user input to select a first tab and a second tab;
displaying the associated elements of the first and second selected tab respectively within a first and second panel of the tabbed pane;
receiving user input to replicate the associated elements of the first and second selected tab respectively for display within a first and second window of the GUI;
replicating the associated elements for display within the first and second window; and
associating the first and second selected tab respectively with the first and second window, wherein the association is signified by respectively changing a visual attribute of the first and second selected tab.

15. The computer usable medium of claim 13, wherein the replication prevents user manipulation of the elements within at least one of:
the panel;
the window; and
the panel and the window.

16. The computer usable medium of claim 13, wherein user manipulation of the elements in the window is replicated within the panel.

17. The computer usable medium of claim 13, wherein user manipulation of the elements in the panel is replicated within the window.

18. The computer usable medium of claim 13, wherein discontinuing the display of the associated elements in the window removes the visual attribute applied to the selected tab.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
